(19) United States
(12) Patent Application Publication
(10) Pub. No.: US 2018/0218895 A1
(43) Pub. Date: Aug. 2, 2018

(54) Method for Removing Trapped Ions from a Multipole Device

(71) Applicant: DH Technologies Development PTE Ltd., Singapore (SG)

(72) Inventors: Bruce Andrew Collings, Bradford (CA); John Vandermey, Georgetown (CA)

(73) Assignee: DH Technologies Development PTE Ltd., Singapore (SG)

(21) Appl. No.: 15/107,141

(22) PCT Filed: Nov. 28, 2014
(86) PCT No.: PCT/IB2014/002605

§ 371 Date: Jun. 22, 2016

Related U.S. Application Data
(60) Provisional application No. 61/935,731, filed on Feb. 4, 2014.
(60) Provisional application No. 61/922,288, filed on Dec. 31, 2013.

(51) Int. Cl. H01J 49/42; H01J 49/00

(52) U.S. Cl. CPC H01J 49/427; H01J 49/4225; H01J 49/423; H01J 49/0027; H01J 49/004

(57) ABSTRACT

A method and apparatus for clearing ions from a multipole ion transmission device which includes introducing a DC or RF clear out pulse to one or more of the rods of the multipole device. The DC pulse is selected so as to supply sufficient kinetic energy to the ions to overcome a pseudo-potential trapping well generated by the RF potentials of the ion transmission device. For an RF pulse, the auxiliary RF signal uses frequencies that correspond to the ejected ion's frequencies of motion. In select embodiments, the multipole device can be a quadrupole or the apparatus can be part of a tandem mass spectrometer.

### RELATED APPLICATIONS

This application claims the benefit of priority from U.S. Provisional Application No. 61/922,288, filed on Dec. 31, 2013 and 61/935,731, filed on Feb. 4, 2014, the contents of both which are hereby incorporated by reference in their entirety.

### FIELD

The teachings herein are directed to methods of clearing ions in mass spectrometry systems.

### BACKGROUND

In tandem mass spectrometry system, multiple mass spectrometer devices are connected in series to achieve enhanced analyzing capabilities. The transfer of ions from one device to the next is therefore an important step in the analysis as improper transfer can lead to inaccurate results.

In general, certain tandem mass spectrometers use multiple multipole devices to move and manipulate ions. For example, a quadrupole device consists of four rods arranged circumferentially around a central longitudinal axis at the four corners of a square with the spacing of the inner face of the rods being a constant distance r₀ (the field radius) from the central axis. The ratio of the diameter of the rods R to the field radius r₀ is approximately 1.126 for round rods. The rods ideally have a hyperbolic cross sectional profile, but are often circular in shape. Quadrupoles can have either RF only or RF and DC voltages applied to it and ion trajectories through a quadrupole are governed by the Mathieu parameters a and q where the DC potentials (resolving DC) are determined by the value of a and the RF amplitudes by the value of q (“Quadrupole Mass Spectrometry and Its Applications”, Peter H. Dawson, American Institute of Physics, 1995, hereby incorporated by reference). A quadrupole setup has two poles (A and B). Each pole consists of two of the four rods (a pair) located directly across from one another on opposing sides of the central axis. The RF on the B pole is shifted by 180° relative to the A pole and the resolving DC on the B pole is the opposite polarity of the resolving DC on the A pole. The ion trajectories through the quadrupole are non-linear and oscillate around some overall trajectory which is either stable (passes through the multipole) or unstable (is radially ejected or contacts one of the rods). Quadrupoles are generally used for mass selection along with ion traps (3D and 2D). Quadrupoles, traps and time of flight devices are used for mass analysis. Other types of multipoles include, but are not limited to hexapoles and octopoles.

A side view of a typical simplified setup of a tandem mass spectrometer device is depicted in FIG. 1. Such a device consists of multiple quadrupole devices (labeled Q0, Q1, Q2 and Q3). Q0 and Q2 operate using only RF voltage and are considered to function as ion guides where the Mathieu stability parameter a equals 0 and q is non-zero. The Q0 region is typically operated at an elevated pressure in the 3 to 10 mTorr regime while the Q2 ion guide is operated at 3 to 10 mTorr during tandem mass spectrometry experiments and can operate as a collision cell. Q1 and Q3 operate with both RF and DC voltages and are used as mass filters that selectively pass through ions having only specific m/z or range of m/z ratios. In addition, situated in front of the Q1 and Q3 mass filters are short quadrupoles (ST1 and ST3) operating in RF only mode that serve as ion transfer devices and can be described as pre-filters since they are situated directly before a filtering quadrupole. ST2 is also an ion transfer device which serves to improve transmission into the Q2 quadrupole, that can operate as a collision cell. Situated directly prior to the pre-filters are lenses (labelled IQ1 and IQ3). IQ2 is another lens positioned prior to the collision cell Q2.

It was found that when using high ion beam intensities in a tandem mass spectrometer the Total Ion Current (TIC) measurements are inconsistent and unstable. Such inconsistencies can lead to inaccurate quantitative measurements such as, for example, plots created for calibration curve purposes where a plot of the signal vs. concentration becomes non-linear at higher count rates. An example of this is depicted in FIG. 2 where a calibration curve generated for the compound sitamaquine demonstrated a deviation of 15% from linearity at a concentration of 500 ng/mL.

Through internal testing, it has been discovered that the non-linearity exhibited in these circumstances is related to ions becoming trapped in the pre-filter regions in the system. Ions can reflect back towards the direction of the ion source at the pre-filter/mass filter boundary (i.e., ST1/Q1 or ST3/Q3 boundaries) when the right conditions are encountered. These reflected ions also lose axial kinetic energy through collisions with the background gas, which is at an elevated pressure closest to the IQ1 and IQ3 lenses, and become trapped in the pre-filter regions. Ions that became trapped in the pre-filter regions can cause a variation in the transmission of ions through the pre-filter. At high ion beam intensities the ions can rapidly fill the pre-filter region causing the ion signal to vary with time until an equilibrium condition has been established.

One method of removing ions from any RF only quadrupole, and more particularly the pre-filters described herein involves the use of a DC pulse applied to the four rods. As an example, the pre-filter region of ST1 can be emptied by pulsing the DC offset on the pre-filter from its transmitting potential to ground potential for a period of 1 ms prior to a scan or Multiple Reaction Monitoring (MRM) experiment. In this scenario, the ST1 potential is such that ions are caused to drain out towards the adjacent IQ1 and Q1 optics and leave the ST1 region. As would be appreciated, though ground potential is used, any suitable relative potential could be used as long as it allows the clearance of ions towards the adjacent devices. The pre-filter DC offset is therefore changed to a repulsive potential relative to the adjacent ion optic that results in the trapped ions moving towards the adjacent optic. This DC pulse empties the pre-filters when moderate ion beam intensities are used, but has been found to be inadequate when very bright ion beam intensities are used. Other techniques such as reducing the RF amplitude on the rods to a level in which ions may escape radially can be utilized but require a separate RF generator to operate the pre-filters independently at RF amplitudes different from the remaining quadrupoles. This can lead to increased cost. In addition, while the amplitude of all the quadrupoles can be lowered collectively, avoiding the use of a separate RF generator, this causes decreases in duty cycle since additional time is required to refill the Q0 quadrupole.

### SUMMARY

It has been found that trapping of ions within multipoles, including the pre-filter quadrupoles that occur with the operation in various mass spectrometer modes of operation is a result of the reflection of ions at the pre-filter quadrupole—filter quadrupole interface (eg. Between ST1 and Q1). It has also been found that this reflection occurs on ions having higher radial amplitudes such as for example when high intensity ion beams are used where space charge effects can lead to expanded ion clouds.

Conventional manners in which ions may be cleared from an ion transmission quadrupole are costly or ineffective and therefore a new method of clearing such quadrupoles is needed.

It has been found that an effective and rapid manner of clearing an ion transmission quadrupole is by creating a potential gradient within the quadrupole that clears the ions from the quadrupole. This is achieved by creating a radial DC pulse on one or more than one of the rods in the multipole setup which forces all of the ions to either move towards or away from the rod(s) with the potential pulse.

In various embodiments, a method of clearing ions from a multipole ion transmission device is disclosed, the multipole having a number of rods arranged circumferentially around and equidistant from a longitudinal axis, each of said rods being connected to a RF generator source and controller so as to generate a multipole field for trapping the ions within the multipole ion transmission device, the method comprising applying a DC pulse to one or more rods of the series of rods up to but not including the total number of rods, the DC pulse being such that the kinetic energy gained by the ions as a result of the DC pulse overcomes the radial trapping force generated by the multipole field.

In various embodiments, a multipole device for use in transporting ions in a mass spectrometer is disclosed, the device comprising: a series of rods arranged circumferentially around and equidistant from a longitudinal axis; at least one RF potential supply that is electrically connected to each rod of the series of rods for generating a multipole field capable of trapping ions; at least one DC potential supply that is electrically connected to at least one of the rods; one or more controllers for controlling the RF and DC potential applied to the rods; wherein the one or more controllers is configured to switch between one of two modes, wherein in the first mode, the DC potential on each rod of the series of rods is the same, and in the second mode, the DC potential on at least one of the rods of the series of rods differs from the DC potential applied to the remaining rods of the series of rods.

In various embodiments, a quadrupole device for use in transporting ions in a mass spectrometer is disclosed comprising: four rods arranged circumferentially around and equidistant from a longitudinal axis; at least one RF potential supply that is electrically connected to each of the four rods for generating a quadrupole field capable of trapping ions; at least one DC potential supply that is electrically connected to at least one of the rods; one or more controllers for controlling the RF and DC potential applied to the four rods; wherein the one or more controllers is configured to switch between one of two modes, wherein in the first mode, the DC potential on each of the four rods is the same, and in the second mode, the DC potential on one or two of the rods is the same and held at a potential that differs from the DC potential on the remaining rods.

In various embodiments, a method of clearing out ions in a quadrupole pre-filter is disclosed, the quadrupole pre-filter comprising first and second pairs of pre-filter rods arranged circumferentially around and equidistant from a first longitudinal axis, the method comprising: connecting the first and second pairs of pre-filter rods to a quadrupole mass filter, the quadrupole mass filter comprising first and second pairs of filtering rods arranged circumferentially around and equidistance from a second longitudinal axis that is in-line to and situated downstream from the first longitudinal axis, wherein the first pair of pre-filter rods is electrically connected in series to the first pair of filtering rods, by way of a capacitor situated therebetween and the second pair of pre-filter rods is electrically connected in series to the second pair of mass filtering rods by way of a capacitor situated therebetween, connecting the first and second pairs of mass filtering rods to an RF voltage source and a DC voltage source, the RF voltage source for generating an RF field in both the quadrupole pre-filter and the quadrupole filter; applying a DC voltage pulse to the first and/or second pair of quadrupole mass-filter rods, wherein the application of the DC voltage pulse causes a resolving DC field in the quadrupole pre-filter to form, the resulting combination of RF field and DC field in the pre-filter capable of removing ions from the quadrupole pre-filter.

In various embodiments, a method of clearing ions from a second quadrupole is disclosed, the second quadrupole being situated in series and upstream from a first quadrupole, said method comprising: electrically connecting a first pair of rods in the first quadrupole to a first pair of rods in the second quadrupole by way of a capacitor situated therebetween, electrically connecting a second pair of rods in the first quadrupole to a second pair of rods in the second quadrupole by way of capacitor situated therebetween, providing RF and DC voltage supplies to the second quadrupole such that the second quadrupole operates as a mass filter, pulsing the DC voltage on the first and/or second pair of rods in the second quadrupole, wherein the pulsing causes a resolving DC field in the first quadrupole to form.

In various embodiments, the amplitude of the DC pulse is increased to provide the kinetic energy.

In various embodiments, the DC pulse is applied to only one of the rods.

In various embodiments, the multipole is a quadrupole.

In various embodiments, the DC pulse is applied to two adjacent rods of the series of rods.

In various embodiments, the DC pulse is applied to two non-adjacent rods of the series of rods.

In various embodiments, the multipole operates as a pre-filter and is situated directly upstream of at least one filtering quadrupole.

In various embodiments, the multipole is part of a tandem mass spectrometer.

In various embodiments, the DC pulse causes ions to move towards the one or more rods of the series of rods with the applied DC pulse.

In various embodiments, the mass spectrometer is a tandem mass spectrometer.

In various embodiments, the multipole operates as a pre-filter and is situated directly upstream of at least one filtering quadrupole.

In various embodiments, the DC potential supply is electrically connected to only one of rods of the series of rods for the application of a DC pulse.

In various embodiments, in the second mode, the DC potential supplied imparts sufficient kinetic energy to the ions to overcome the multipole field capable of trapping ions.

In various embodiments, in the second mode, the DC potential on the one rod of the series of rods is selected so at to cause the ions to move towards the one rod of the series of rods.

In various embodiments, the mass spectrometer is a tandem mass spectrometer.

In various embodiments, the quadrupole device operates as a pre-filter and is situated directly upstream of at least one filtering quadrupole.

In various embodiments, the DC potential is electrically connected to only one of the four rods for the application of a DC pulse.

In various embodiments, in the second mode, the DC potential supplied imparts sufficient kinetic energy to the ions to overcome a trapping field that traps ions that is generated by the quadrupole field.

In various embodiments, the controller is configured such that in the second mode, the DC potential on one of the rods differs from the DC potential on the other three rods and is selected so as to cause ions to move towards the one rod that has the differing DC potential.

In various embodiments, the controller is configured such that in the second mode, the DC potential on two adjacent rods is the same and differs from a DC potential on the other two rods.

In various embodiments, the controller is configured such that in the second mode, the DC potential on two non-adjacent rods is the same and differs from a DC potential on the other two rods.

The term effective voltage is meant to refer to the overall voltage applied to the rod or rods to generate an electric field that affects the trajectory of ions through the multipole device. For the case of a quadrupole, such a trajectory can be determined by using the Mathieu's stability equations.

In embodiments, when the DC potential supply is not connected to a specific rod, the DC potential for said rod would be understood to be 0V. In this manner, when a DC potential supply is only connected to one rod, the remaining rods would be understood to have the same DC potential of 0V.

In various embodiments, a method of clearing an ion from a quadrupole ion transmission device is disclosed, the quadrupole ion transmission device having two sets of poles, each pole having two rods, each of said rods being connected to an RF generator source and controller, said source and controller for generating a quadrupole field for trappings ions within the ion transmission device, the method comprising generating an auxiliary RF field for a period of less than 1 ms at a frequency that corresponds to a frequency of motion of said ion.

In various embodiments, the auxiliary RF field is generated by applying an auxiliary RF voltage signal to one set of said poles.

In various embodiments, the auxiliary RF voltage is generated by a separate RF generator source and transmitted to the one set of said poles through the use of a transformer, preferably the transformer can be a torodial transformer.

In various embodiments, the quadrupole ion transmission device also comprises at least one pair of auxiliary electrodes disposed within the spacing between the two sets of poles and said auxiliary RF field is generated by applying an auxiliary RF voltage signal to said at least one pair of auxiliary electrodes.

### BRIEF DESCRIPTION OF THE DRAWINGS

FIG. 1 depicts the a side view of a layout of a typical tandem mass spectrometer

FIG. 2 depicts a mass spectrometer based calibration curve for the compound sitamaquinen.

FIG. 3 shows a low intensity TIC for m/z 609.

FIG. 4 shows the spectra generated for m/z 609 at a low intensity TIC.

FIG. 5 depicts TIC as a function of various voltages during ion transmission after a four rod drop out pulse

FIG. 6 depicts a simplified view of the Q0/IQ1/ST1/Q1 setup interface with the spatial DC potential along interface during various scenarios involving a four rod drop out pulse.

FIGS. 7 and 8 depict reflected ion trajectories in the Q0/IQ1/ST1/Q1 setup

FIG. 9 depict the cross sectional arrangement and DC voltages and exemplary potential contours of a quadrupole in accordance with an embodiment of the present invention.

FIG. 10 depicts exemplary DC voltages on a quadrupole during a single rod pulse

FIG. 11 depicts the potentials contribution along the axis between the two A pole rods and the axis between the B pole rods.

FIG. 12 depicts the theoretical pseudo-potential well depth as a function of mass and drive frequency.

FIG. 13 depicts a simulation of ion trajectories during no pulse operation in a tandem quadrupole setup

FIG. 14 depicts a simulation of ion trajectories during the implementation of a single rod DC pulse in a tandem quadrupole setup.

FIG. 15 depicts an exemplary circuit for implementing a single rod DC pulse

FIG. 16 depicts TIC traces for m/z 609 with ST1=−18V with no DC drop out pulse

FIG. 17 depicts TIC traces for m/z 609 with ST1=−18V with a −250V DC drop out pulse on one rod for 1 ms

FIG. 18 depicts TIC traces for m/z 609 with ST1=−30V with no DC drop out pulse

FIG. 19 depicts TIC traces for m/z 609 with ST1=−30V with a −250V DC drop out pulse on one rod for 1 ms

FIG. 20 depicts an exemplary circuit for implementing a multi-rod pulse

FIG. 21 depicts a DC response curve utilizing the circuit of FIG. 20

FIG. 22 depicts a circuit diagram for an alternative embodiment that generates an auxiliary RF pulse for clearing out ions

FIG. 23 depicts a circuit diagram for an alternative embodiment that generates an auxiliary RF pulse for clearing out ions

### DETAILED DESCRIPTION OF EMBODIMENTS

While the following embodiments particularly describe the use of quadrupoles, as would be appreciated, the within teachings can be applied to any device using rods with a suitable arrangement connected to suitable power supply devices for the purpose of manipulating ions. Such devices, for example can be utilized as pre-filters in mass spectrometry analysis.

In some embodiments, the pre-filter quadrupoles can be emptied by changing the DC offset potential applied to a single rod only while maintaining the normal DC potential on the remaining three rods. This effectively creates a gradient from/to one rod to/from the other three rods which forces any trapped ions to be ejected or neutralized on at least one of the rods depending on the potential offset applied to the one rod.

Deviation from Linearity in the Linear Dynamic Range Test

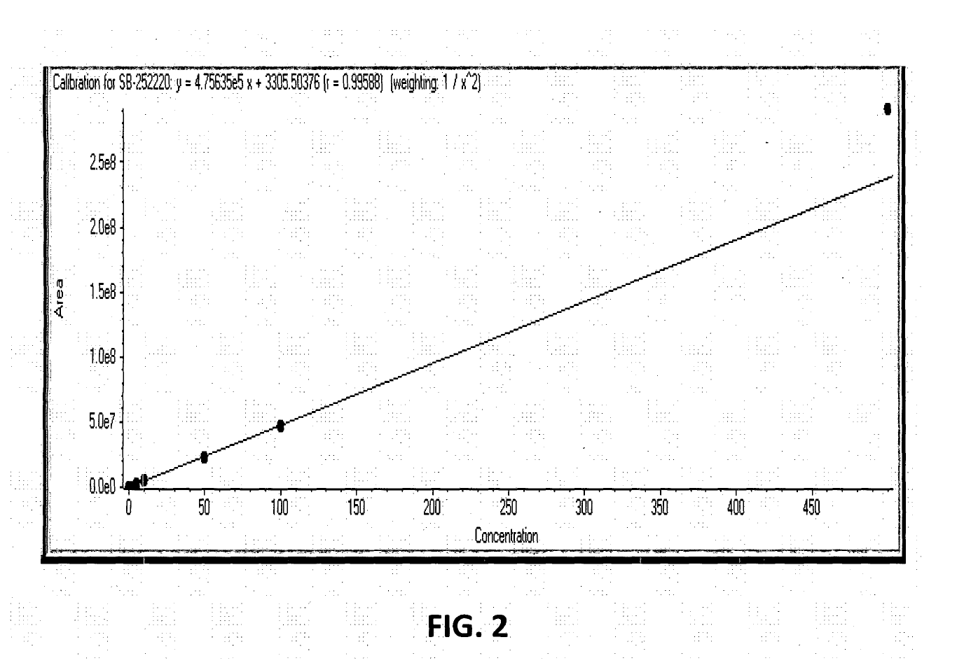

A plot of sitamaquine concentration vs. signal intensity is depicted in FIG. 2. At 500 ng/mL there is a deviation from linearity at 9.3×10⁷ cps representing a difference of approximately +15% when plotting peak area vs. concentration.

### Experimental Evidence for Trapping in the Stubby Regions

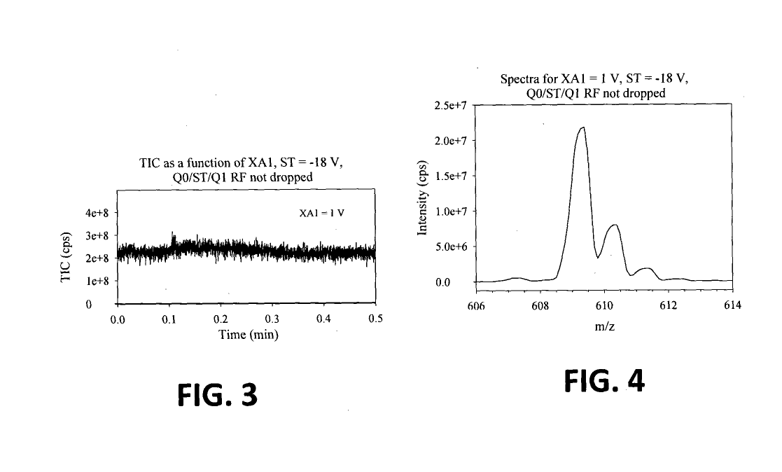

Spectra were collected for periods of 0.5 minutes, at a scan rate of 1000 Da/s, while scanning over a mass range of 8 Da spanning m/z 606 to m/z 614. The experiments produced TIC's which normally had some slight instability which was attributed to fluctuations in the ion source and syringe pump, amongst other things. A typical Total Ion Current (TIC) for count rates of around 2.2×10⁷ cps at m/z 609 is shown in FIG. 3, while the spectrum for the data is shown in FIG. 4.

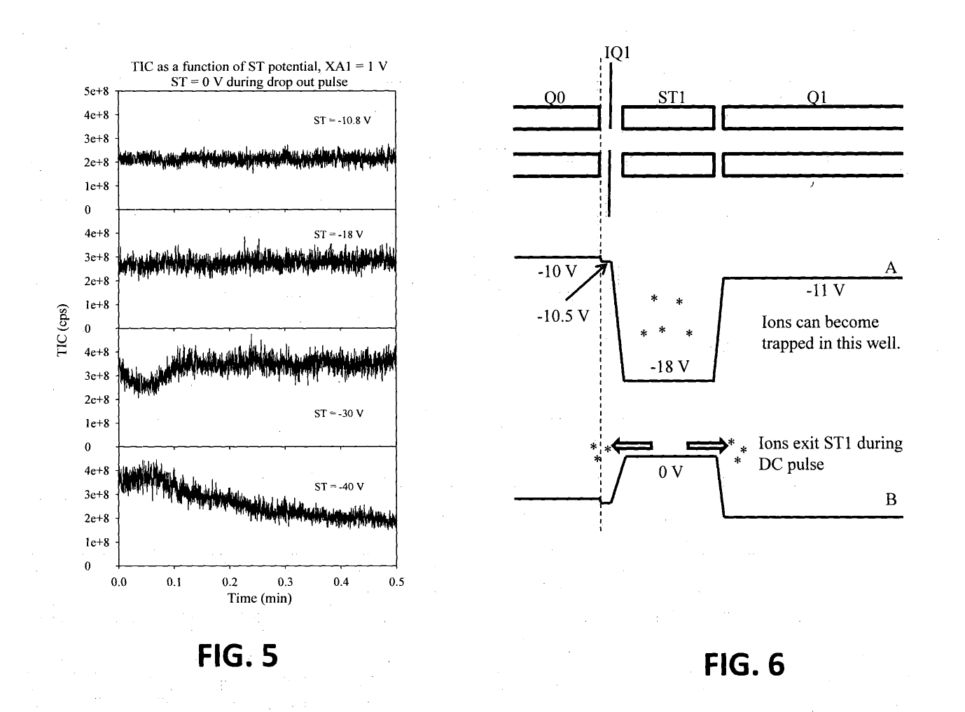

FIG. 5 depicts a series of Total Ion Current plots as a function of the pre-filter quadrupole DC offset potential. As depicted in FIG. 6, the DC offsets for the adjacent Q0/IQ1 and Q1 optics are −10/−10.5 and −11V, respectively. In each of these cases, a clear out pulse is applied to the potential on the four pre-filter rods which causes the potential to rise to 0V for 1 msec. The DC potential is set to the value indicated in the figure at all other times. At higher DC potentials, the problem of trapping in the pre-filter region shows up as significant variations in the TIC with time. This becomes evident when the DC potential on the pre-filter is set to −30 and −40 V. When the ion beam passes through the pre-filter region the ions can reflect back at the pre-filter/mass filter boundary. Ions that undergo collisions with the background gas will lose axial kinetic energy and become trapped. The number density of the ions trapped will vary until the density reaches a maximum limited by the depth (pre-filter DC potential difference relative to the IQ1 and mass filter DC potentials) of the well. Focusing of the ions through the pre-filter region is a function of the density leading to variations in the TIC. Once the density of ions trapped in the pre-filter region reaches a maximum the TIC will become stable. If the pulse on all four rods were doing an adequate job of clearing the pre-filter region then it would be expected that the TIC would remain stable, regardless of the DC potential offset applied to the pre-filter.

FIG. 6 shows a schematic of the Q0/IQ1/ST1 and Q1 regions and the expected result of the use of a DC pulse on the four rods of the quadrupole. The DC potentials labeled A apply for scans using an ion energy of 1 eV into the Q1 mass filter. The ST1 optic is set to transmit at about −18 V to provide maximum transmission of the ion of interest. During the DC pulse intended to clear ST1, the potential on ST1 goes to 0 V and is shown in B. Ions can then move out of the pre-filter region within a short period of time using thermal axial kinetic energy or residual axial kinetic energy from when they when trapped. The ions can move towards the IQ1 optic and the mass filter thereby clearing the pre-filter of trapped ions. Experiments were carried out in which the pre-filter DC potential was set to −10.8 V at all times. This removes any possibility of ions being trapped in the pre-filter region by the axial DC fields. The TIC's were stable regardless of the ion beam intensity indicating that the ion density in the stubby region was constant throughout the experiments.

Ions however become trapped in the pre-filter region, when the pre-filter DC potential produces an axial well, leading to variations in the transmitted ion beam intensity. This impacts the measurement accuracy of samples which are monitored during an experiment. Intensities recorded will be dependent upon the number of ions that entered the pre-filter region in the previous time period, which can be on the order of several seconds or longer. The deviations are expected to be more significant as the number of ions trapped in the pre-filter region increases.

### Mechanism of Trapping

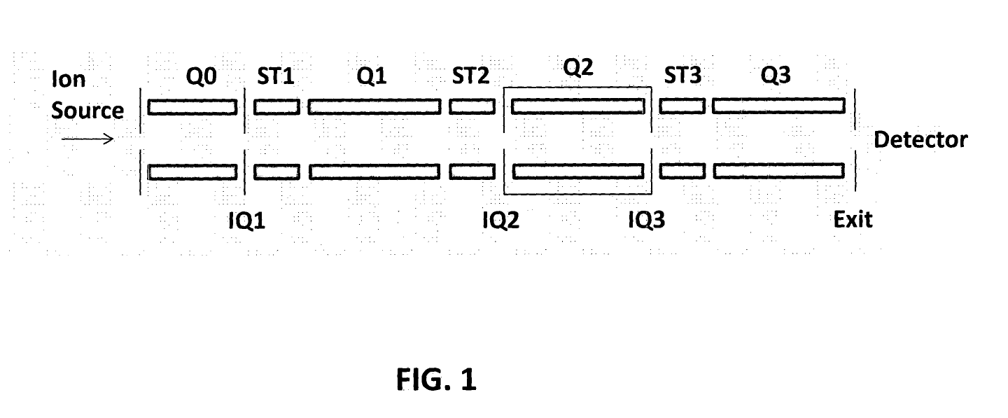

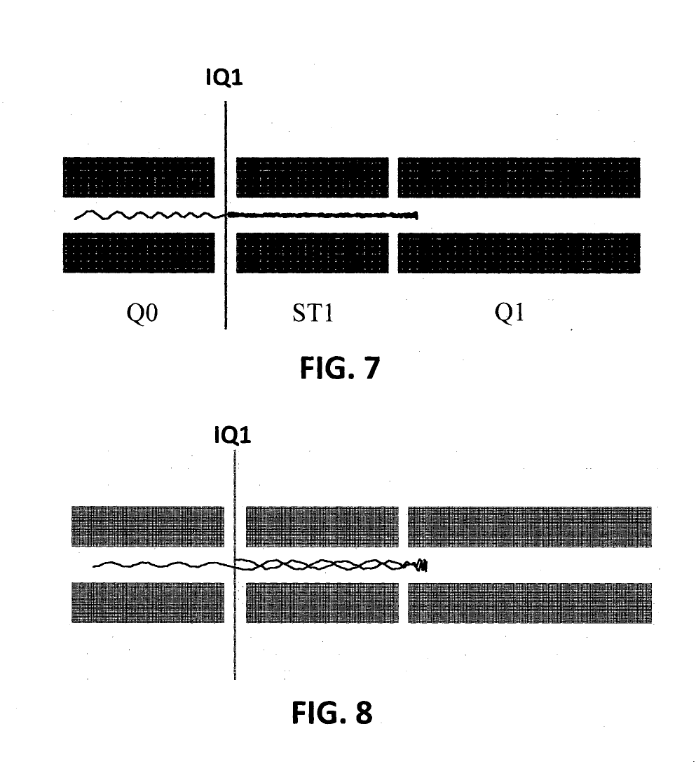

The mechanism of undesired trapping can be more easily visualized using the simulation results described below. Using Simion® 8.07.47, a model was built simulating the operation of a portion of the system generally described in FIG. 1. In particular, the model consisted of the last 25 mm of the Q0 ion guide, the differential pumping aperture, the pre-filter ST1, and the first 40 mm of the mass analyser Q1. Initial ion kinetic energies were held constant at 5 eV along the quad axis moving towards Q1. The ions were distributed on axis using a 3-D Gaussian distribution with a standard deviation of 0.1 mm. The pressure in Q0 was held at 7 mTorr while the pressure in the pre-filter region was reduced in a quadratic fashion to 0.01 mTorr along the longitudinal axis, while the mass filter region was held at 0.01 mTorr. A collision cross section of 280 Å² was used with nitrogen as the collision gas and m/z 609 as the ion. Ion trajectories were terminated after 1 ms with a sample ion trajectory shown in FIG. 7. In this example the ion has reflected back and forth several times between the IQ1 lens and the pre-filter/mass filter boundary.

Mathieu q values of 0.47, 0.47 and 0.706 were chosen for Q0, ST1 and Q1 respectively. Q1 had Mathieu a=0.2. Offset potentials were 0, −0.5, −8 and −1 V respectively for Q0, IQ1, ST1 and Q1. As seen in FIG. 7, an ion trajectory which normally travels from left to right reflects at the ST1/Q1 boundary and also reflects near IQ1 after losing axial kinetic energy through collisions with the nitrogen. The ion becomes trapped in the pre-filter region. The reflection and trapping effect becomes more prevalent the greater the radial displacement of the ions initial starting position from the quadrupole axis. This effect is expected to occur to a greater extent with space charge repulsion of the ions in high intensity ion beams.

In FIG. 8, the gas has been removed from the simulation. In this situation ion trajectories that reflect back at the pre-filter/mass filter boundary terminate on the IQ1 lens or, in a few cases, pass back through the IQ1 lens and into the Q0 ion guide region. This demonstrates the need of having axial kinetic energy loss through collisions of the ion with the background gas resulting in ions becoming trapped in the pre-filter region.

### Removal of Ions

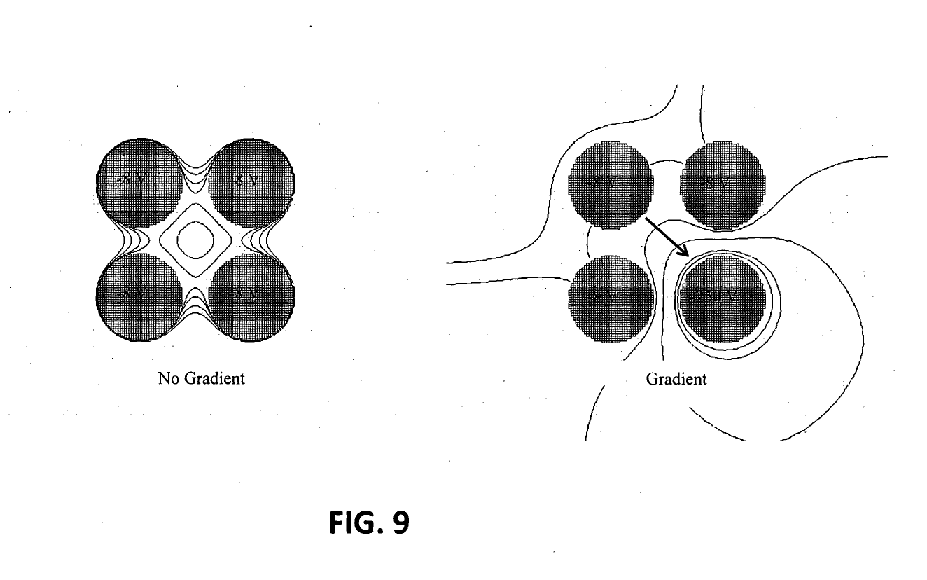

Consistent with the present teachings, trapped ions can be removed from the pre-filter region by applying a DC clear out pulse to one of the pre-filter rods. This phenomenon is depicted in FIG. 9 in which a gradient is created. In this example, changing the DC potential offset on one rod from −8 V to −250 V causes positive ions to move towards the pole with the −250 V. The magnitude of the pulse has to be high enough for the ion to gain enough radial kinetic energy to overcome the pseudo-potential trapping the ion that is created by the RF fields applied to the quadrupole rods.

The amount of kinetic energy that can be imparted to the ion from a DC pulse can be approximately calculated. Assuming that the ion starts on the quadrupole axis, the potential at that point can be calculated by taking a linear supposition of the DC fields resulting from the applied DC to the four rods.

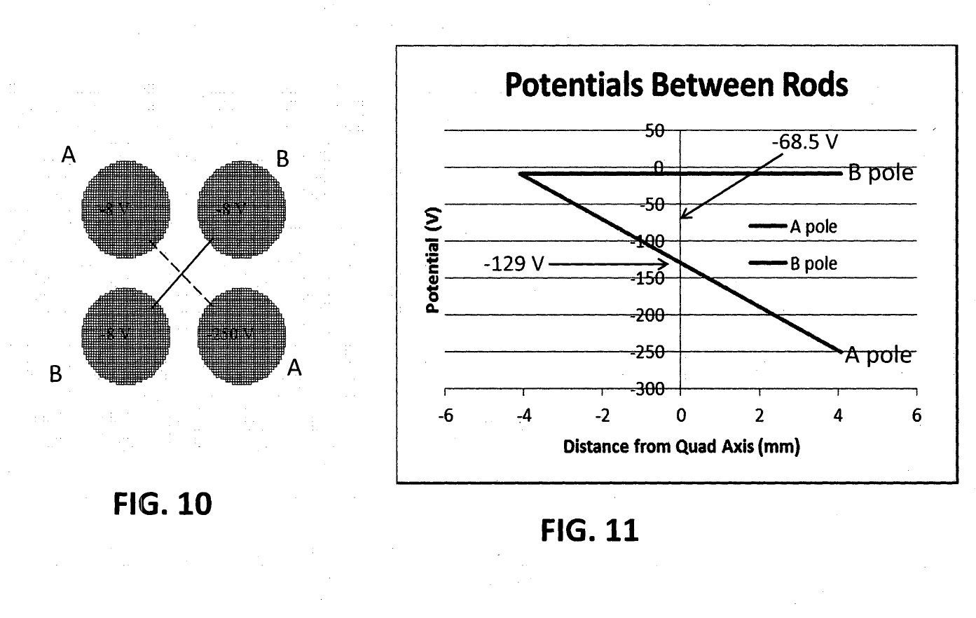

FIG. 10 shows the potentials applied to the rods during a pulse with the potential raised from −8 V to −250 V on one of the A-pole rods. The contribution to the potential as a function of the distance between the A-pole rods and B-pole is shown in FIG. 11. At the quadrupole axis, located at a distance of 0 mm, the potential from the A-pole is −129 V while the potential from the B-pole is −8 V. The potential that the ion experiences will be an average of these two values, −68.5 V. The maximum kinetic energy that the ion can gain is the potential difference between the rod it is heading towards and the potential on the quadrupole axis. In this example the potential difference is 181.5 V which gives a singly charged ion a kinetic energy of 181.5 eV. This can be represented in equation form by the following equation.

$$Potential Difference = {A}^{′} - ( \frac{( {A}^{′} + {A}^{″} )}{2} + \frac{( {B}^{′} + {B}^{″} )}{2} ) / 2 \qquad ( 1 )$$

where A′ and A″ are the offsets on the A-pole rods, with the pulse applied to A′, and where B′ and B″ are the offsets on the B-pole rods. In this equation it is assumed that the ion is attracted to the A′ rod.

In addition, contributions from micro-motion due to the RF trapping fields should also be included in order to accurately calculate the ions kinetic energy. The final maximum kinetic energy from the pulse will also depend upon where the ion starts spatially. The further away from the rod that has the pulse applied then the higher the final maximum kinetic energy that is attainable.

The pseudo-potential well depth, D̅, can be calculated using the below two equations.

$$\begin{matrix}\overline{D} = \frac{{qV}_{rf}}{4} & ( 2 ) \\ {V}_{rf} = \frac{{qmr}_{0}^{2} {Ω}^{2}}{4 {eA}_{2}} & ( 3 )\end{matrix}$$

Where q is the Mathieu parameter, V_{rf} is the RF amplitude measured pole to ground, m is the mass of the ion, r₀ is the field radius of the quadrupole, Ω is the angular drive frequency, e is the electric charge and A₂ (1.001462) is the quadrupole field content for the round rods with R/r₀=1.126.

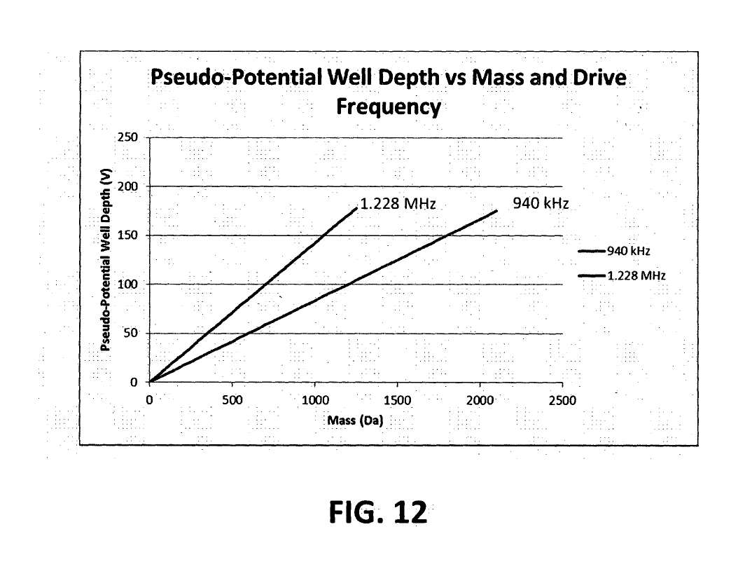

FIG. 12 shows a plot of the calculated pseudo-potential as a function of both mass and drive frequency. A drive frequency of 1.228 MHz is used for the low mass range while a drive frequency of 940 kHz is used for the high mass range. The pseudo-potential well depth has a maximum of about 180 eV for both mass ranges.

In order to empty the pre-filter region, the amount of kinetic energy imparted to the ion has to be greater than the pseudo-potential well depth. The magnitude of the pulse applied to the rod can either be set at a value equal to the pseudo-potential well depth plus a fixed offset or it can be set to a value that is greater than the maximum that would be needed for any mass.

Calculation of the amplitude of the clear out pulse must take into account the q values of other ions that are higher and lower than the mass of interest (the mass that the mass filter is transmitting) that can be present at the same time as the mass of interest. All ions will have the same V_{rf} as the mass of interest. Therefore, masses greater in mass than the mass of interest will have q values lower than the mass of interest while lighter masses will have q values higher than the mass of interest with the highest stable q value at 0.908, the low-mass cut-off. The maximum pseudo-potential can be calculated, using the q value at the low mass cut-off, with the following equation

$$\overline{D} = \frac{{q}_{prefilter} \times {V}_{rf , prefilter}^{max}}{4} \times \frac{{q}_{LMCO}}{{q}_{prefilter}} = \frac{{q}_{LMCO} \times {V}_{rf , prefilter}^{max}}{4} \qquad ( 4 )$$

Which is a factor of 0.908/0.47=1.93 times greater than that given previously from equation (2) where the pseudo-potential was calculated using q=0.47.

This equation gives the kinetic energy that an ion can gain if it starts on the axis of the quadrupole and moves towards the rod with the clear out pulse applied, the A′ rod. The maximum pseudo-potential using q=0.47 and the maximum mass was 180 V. The removal of ions trapped with the maximum RF amplitude but at q=0.908 raises the pseudo-potential to 180 V×1.93=347 V. This is the maximum value that the Potential Difference from equation (2) would have to equal to ensure that the DC pulse would remove trapped ions in every situation. Equation (1) can be rearranged to solve for A′ using the substitution A″=B′=B″ and Potential Difference=D̅ which then gives

$${A}^{′} = \frac{4}{3} \overline{D} + {A}^{″} \qquad ( 5 )$$

The maximum required clear out pulse amplitude is then A′-A″=(4/3)*347 V=463 V to empty the pre-filter region when the quadrupole is operated at the maximum of its mass range.

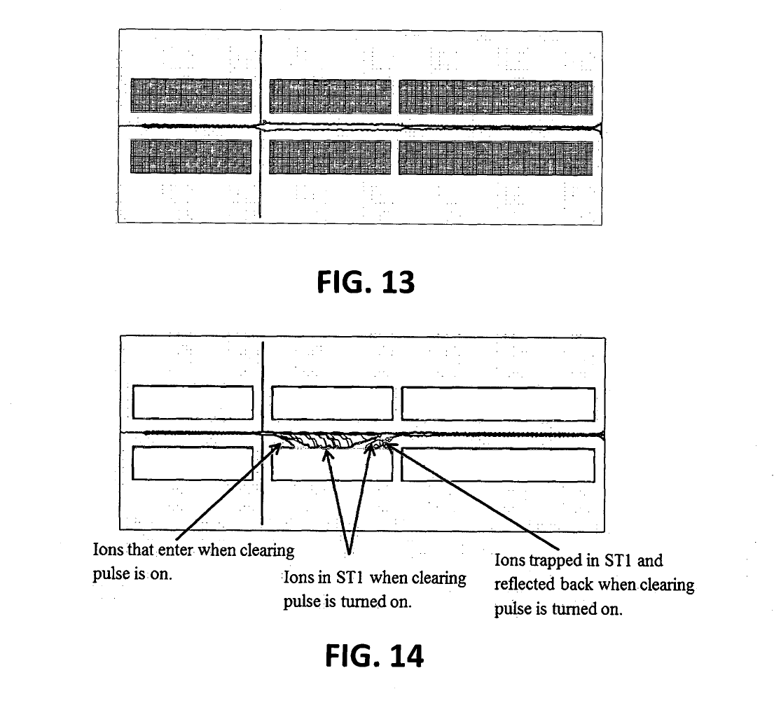

FIGS. 13 and 14 show examples of ion trajectories (for m/z 609) with and without the clear out pulse activated, respectively. The DC potentials chosen for the pre-filter were those displayed in FIG. 9. In FIG. 13, 100 ions trajectories are displayed with each trajectory being terminated at the simulation boundary or after 1 ms.

In FIG. 14, the DC pulse is activated after a period of 100 μs. The figure demonstrates that some ions are moving fast enough to pass through the pre-filter before the clear out pulse is activated, in which case they pass through Q1 and terminate at the simulation boundary. Ions that enter the pre-filter when the clear out pulse is on or are already trapped in the pre-filter collide with a pre-filter rod. The simulations also indicate that a duration of only a few (two to five) RF cycles are required to clear the ions out of the pre-filter region.

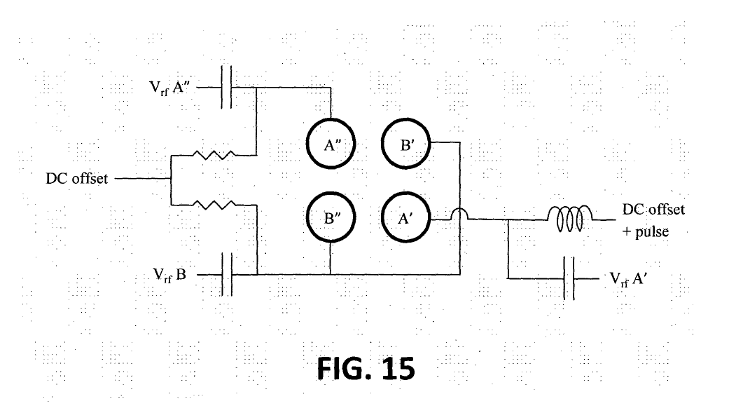

Experiments were performed on a multi-quadrupole device which contained a high dynamic range detector. The hardware was modified to allow a DC pulse to be added to the A′ rod of the pre-filter (ST1) optic. The clear out pulse was applied for a duration of 1 ms at the beginning of a pause time. A pause time of 5 ms was used for all experiments and is intended to allow the ion beam to equilibrate along the ion path prior to the start of a measurement. A schematic of the modification is shown in FIG. 15. The sum of the clear out pulse and the DC offset potential was applied to the A′ rod. This potential was applied through an inductor which was connected close to the A′ rod.

The pre-filter DC offsets used for these experiments were −18 and −30 V. The DC offsets on the Q0/IQ1 and Q1 optics were −10, −10.5 and −11V, respectively. The A′ rod was pulsed to −250 V for removal of the ions trapped in the pre-filter. These potentials were used for positive ion mode only.

A solution of 1 ng/μl reserpine was infused at 7.0 μl/min. The mass range 606-614 Da was scanned at 1000 Da/s. The intensity of the first isotope was adjusted to approximately 10⁸ cps by adjusting the RF amplitude on an upstream quadrupole ion guide.

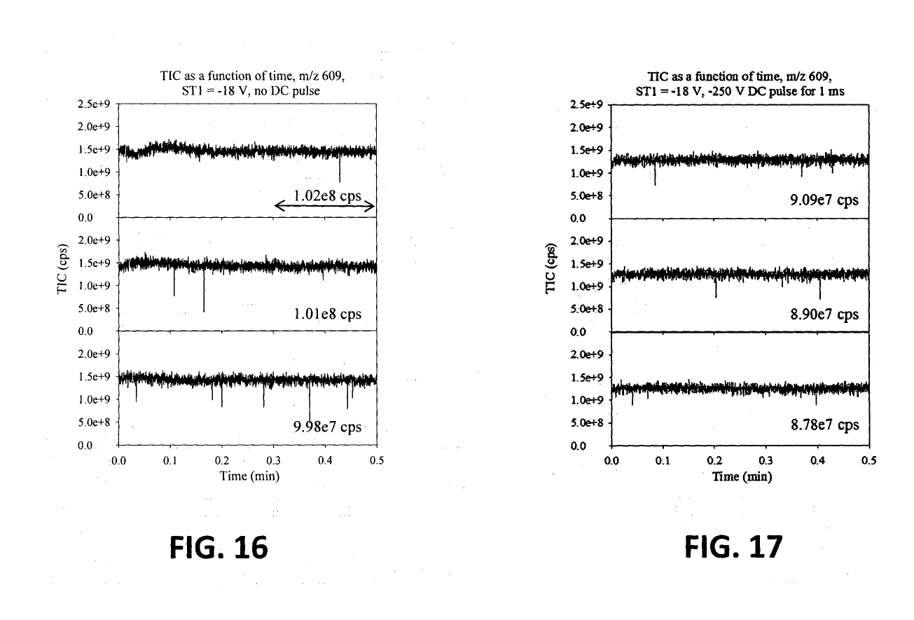

FIG. 16 shows TIC traces as a function of time with all four rods of the pre-filter held at a potential of −18 V. No clear out pulse was applied to the A′ rod. The TIC shown in the top frame was taken immediately after a short scan at m/z 30, width 8 Da. The purpose of the low mass scan is to empty the pre-filter region of any trapped ions. The TIC is unstable for the initial 0.2 minutes. Repeating the experiment right away gives the TIC's shown in the middle and then the lower frames. In the subsequent scans, the TIC is not quite as unstable due to the fact that the pre-filter is still filled with trapped ions and an equilibrium condition has been achieved. A slight dip at the beginning of each experiment is visible which is the result of the Q1 mass jumping down to the park mass which was set to 565 Da for this instrument at the end of each experiment. The count rate shown in each frame represents the peak intensity for m/z 609. It was determined using data from 0.3 to 0.5 minutes.

FIG. 17 shows data collected for the same experiments except that now the clear out pulse is activated. Before each experiment an experiment is carried out with Q1 set to m/z 30. In this data the TIC is now stable for the duration of each experiment. The intensity data is about 10% lower than the data of FIG. 16.

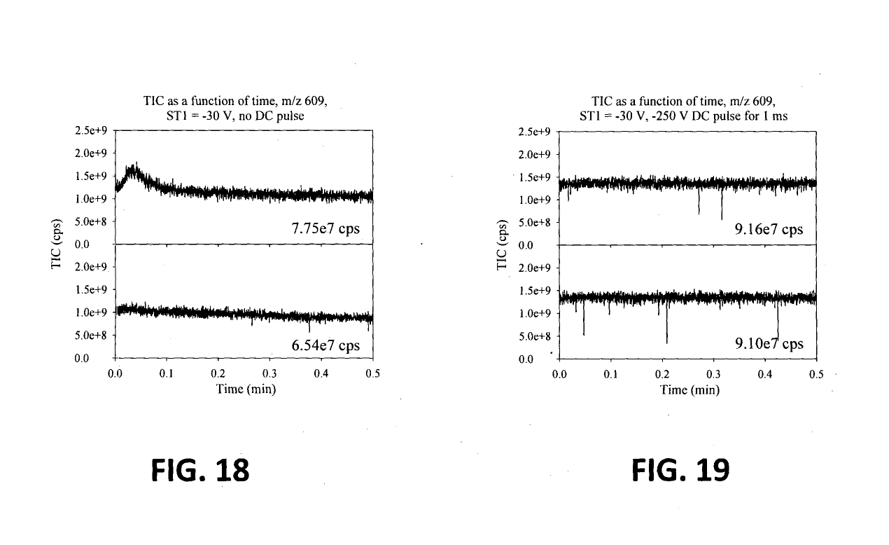

FIGS. 18 and 19 show the same type of experiments except that now the DC offset applied to the pre-filter is −30 V. Previously it was found that the larger the magnitude of the DC offset applied to pre-filter then the more pronounced the instability in the TIC. The data of FIG. 18 has no clear out pulse applied while the data of FIG. 19 does. The top frame of FIG. 18 shows data taken after an experiment in which the Q1 mass was set to m/z 30. The TIC continues to decrease and does not become stable even in the second experiment shown in the bottom frame. The observed ion count continues to decrease with time. In FIG. 19 the use of the clear out pulse leads to stable TIC's. In this particular case the ion intensities have increased when the clear out pulse was applied which is opposite to that seen above in FIGS. 16 and 17 when the DC offset was set to −18 V.

While the above described technique is described specifically for use with pre-filter quadrupoles, the technique described can also be used to rapidly empty other quadrupoles, such as the Q2 collision cell. For example, ions starting on axis of the collision cell with no RF applied to the collision cell rods and a pressure of 7 mTorr and given thermal energies (0.025 eV) required from several tens of microseconds to a few hundred microseconds to terminate upon the rods. Calculation of the travel times for m/z 1250 and m/z 2000 to travel a distance equal to the field radius (4.17 mm) gave values of 67 and 85 μs, respectively. These values were calculated for the collision free case and the ions were given initial kinetic energies of 0.025 eV. If there is a need to empty the collision cell more rapidly then applying a clear out pulse will clear the region in <5 μs, which is significantly faster than by simply dropping the RF amplitude on the quadrupole rods.

While specific embodiments have been described wherein a DC pulse is applied to only one of the rods, the clearing of the ions can also be achieved by applying the DC pulse to two adjacent rods, or three rods in for example, the operation of a quadrupole device. By adjacent, it is intended to mean that when the rods are viewed in cross sectional form, and are depicted as being arranged circumferentially around a central axis, as seen for example in FIG. 10 for the case of the quadrupole, the DC pulse can be applied to the top right rod and either the top left rod or the bottom right rod. In a multipole setup containing a specified number of rods, the DC pulse can be applied to up to one less than the number of rods present. In use, the application of the DC pulse to two adjacent rods in a quadrupole setup would drive trapped ions to the spacing between the two rods. This has benefits in reducing ion contamination on the pre-filter rods as ions are ejected from the quadrupole through the spacing, rather than deposited on a single rod.

Furthermore, for the case of quadrupoles, ions may be cleared by application of the DC pulse to two of the rods where the two rods are non-adjacent (i.e., they are directly opposite of one another across the central longitudinal axis). In this manner, the applied DC pulse creates resolving DC which clears out ions according to the regions of instability defined by the Mathieu equations.

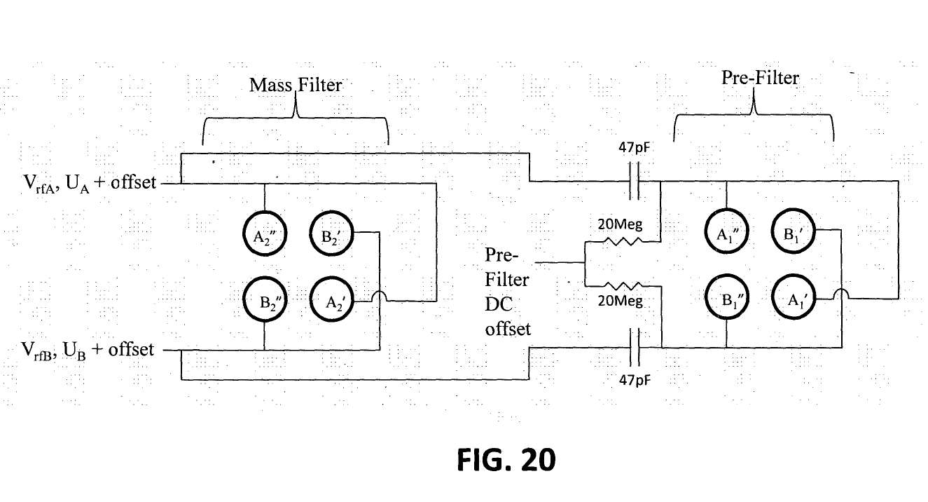

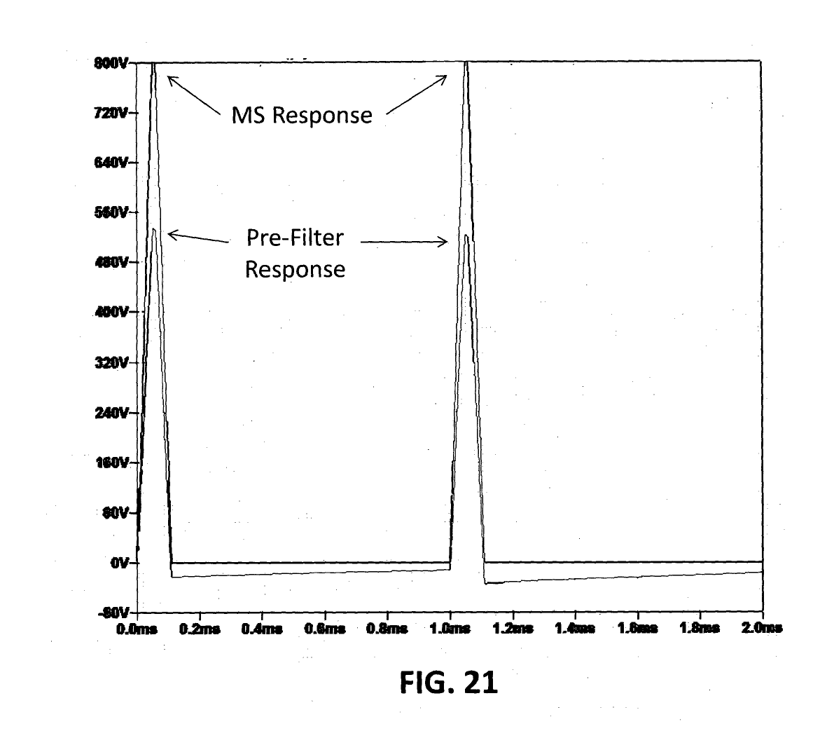

In another embodiment, it is possible to create resolving DC in a pre-filter in a manner set out for example in FIG. 20. In this embodiment, the pre-filter rods (A₁′, A₁″ B₁″ B₁′) consist of pairs of rods and are electrically connected through capacitors to the RF (V_{rfA}, V_{rfB}) and DC (U_{A}, U_{B}) voltage supplied by a mass filter. In this fashion, no separate RF or DC voltage supply is required for the pre-filter. RF voltages applied to the two pairs of rods of the mass filter (A₂′, A₂″ B₂″ B₂′) are also transmitted to the rods of the pre-filter used for generating appropriate RF fields. A DC pulse can be applied to one (via Uₐ or U_{b}) pair of the quadrupole mass filter rods or both (via Uₐ and U_{b}) pairs of the quadrupole mass filter rods that will clear the pre-filter since the DC pulse is intermittent and partially transmitted through the capacitor during the charging phase. However, when the mass filter is operating in its normal resolving mode when a constant DC voltage is being applied, the capacitor prevents the transmission of or generation of a DC voltage to the pre-filter, thus allowing the pre-filter to operate as a transmission only device. The effect of such a method is depicted in FIG. 21 when a 800V DC pulse is applied to one pair of the mass filtering rods for a period that includes a 50 μs rise, a 10 μs duration and a 50 μs fall. This results in the creation of an approximately 520V DC pulse in one of the pairs of the pre-filter rods due to the presence of the 47 pF capacitors and the 20 MOhm resistors. As would be appreciated, the capacitor must be so chosen so that a DC pulse applied to the mass filter will be appropriately transmitted via the capacitor to the pre-filter such that a resolving DC field is generated within the pre-filter. The pulse applied to the mass filter rods and the appropriate capacitor must be so chosen that the resulting DC pulse transmitted is sufficiently long to cause the removal of the ions from the pre-filter. This typically entails a length of more than one RF cycle.

In another embodiment, the pre-fitter region can be emptied using an alternative mechanism that utilizes an auxiliary RF signal. Ions trapped within the pre-filter will have frequencies of motion that are determined by the frequency and amplitude of the drive RF applied to the pre-filter. By pulsing an auxiliary RF signal at selected frequencies that correspond to the ion's frequencies of motion, the ions will be excited to larger radial amplitudes which will lead to their collision with the pre-filter rods, causing them to be removed.

In another embodiment, the pre-filter region can be emptied using an alternative mechanism that utilizes an auxiliary RF signal. Ions trapped within the pre-filter will have frequencies of motion that are determined by the frequency and amplitude of the drive RF applied to the pre-filter. By pulsing an auxiliary RF signal at selected frequencies that correspond to the ion's frequencies of motion, the ions will be excited to larger radial amplitudes which will lead to their collision with the pre-filter rods, causing them to be removed.

The secular frequency of an ion can be determined from knowledge of the Mathieu q and a parameters associated with the ion. In the case of the pre-filter there is no resolving DC applied leading to a=0. The Mathieu q parameter is defined by

$$q = \frac{4 {eV}_{rf}}{{mr}_{0}^{2} {Ω}^{2}}$$

where m is the mass of interest, r₀ is the field radius of the pre-filter, Ω is the drive frequency and V_{rf} is the RF amplitude applied to the pre-filter measured zero to peak, pole to ground. The ions' secular frequency of motion is defined by

$${ω}_{0} = β \frac{Ω}{2}$$

where β can be approximated by

$$β = {[ a + \frac{{q}^{2}}{2} ]}^{1 / 2}$$

for the case q<0.4. For larger q values a more rigorous definition utilizing the continued fraction expression as described in equation 28 of “An Introduction to Quadrupole Ion Trap Mass Spectrometry” R. E. March, J. Mass Spectrom. 32, 351-369 (1997), incorporated by reference. It should however be noted that the expression “(βᵤ+4)⁴” in equation 28 should be corrected to “(Bᵤ+4)²”

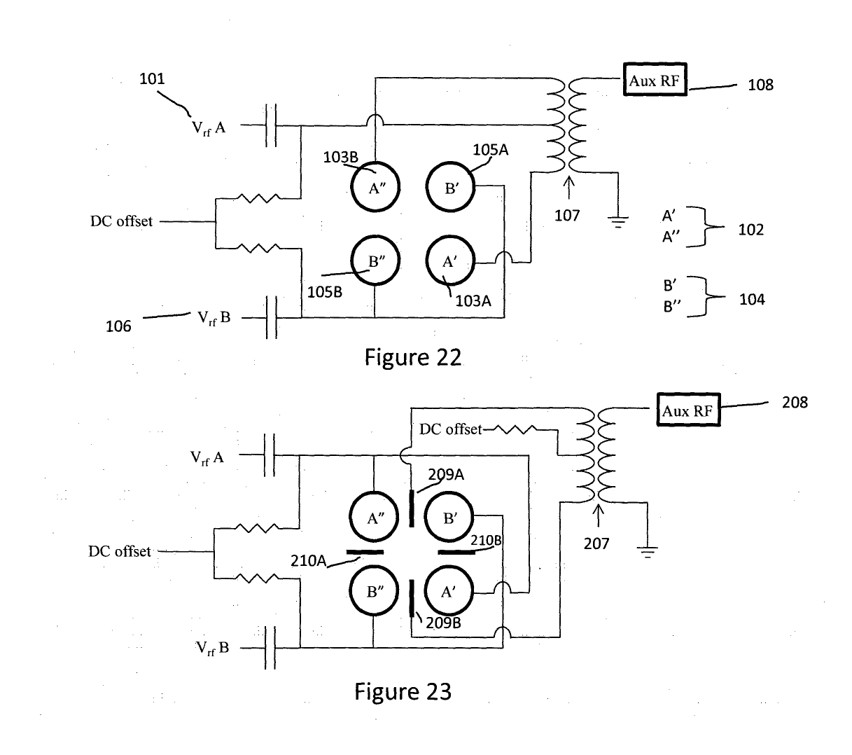

By applying a short (less than 1 ms and preferably of the order of a few microseconds) Auxiliary RF pulse on one pole of the pre-filter ion optic, ions can be removed. One method of applying an auxiliary RF pulse involves the use of a transformer and applying the RF in the manner depicted in FIG. 22 in which a dipolar signal is applied on the A′ and A″ electrodes. In an alternative embodiment, the Auxiliary RF pulse need not be applied to the main pre-filter electrodes. Such an embodiment is depicted in FIG. 23 in which a dipolar signal is applied across a pair of auxiliary electrodes inserted between the main rods/electrodes of the pre-filter. The DC offset circuitry for applying the DC potential has not been shown. It should also be recognized that other forms of excitation can be applied, such as quadrupolar excitation.

Referring to FIG. 22, an alternative embodiment demonstrating a circuit that can be used to create an auxiliary RF pulse to a single pole of a pair of poles contained within a quadrupole is depicted. First RF voltage source 101 is connected to and paired with a first pole 102 consisting of a pair of electrodes/rods (103A, 103B) (labelled A′ and A″) situated in a quadruple arrangement with a second pole 104 consisting of a second pair of electrodes/rods (105A, 105B) (labeled B′ and B″). The second pole 104 consisting of a second pair electrodes (105A, 105B) is connected with a second RF voltage source (106). Each of these voltage sources (101, 106) is corrected for any DC offset through conventional means. The first and second poles (102, 104) and associated voltage sources (101, 106) can be utilized to generate a quadrupole field. The first pole 102 is additionally linked via transformer 107 to an Auxiliary RF voltage source 108. In one embodiment, the transformer can be a torodial transformer. By introducing a short Auxiliary RF pulse in accordance with the determination of a suitable frequency so chosen by the above described methods relating to the Mathieu equation, ions having certain frequencies can be made to radial displace with the quadrupole causing them to be removed.

Referring to FIG. 23, an alternative embodiment similar to FIG. 22 is depicted however rather than create the auxiliary RF field by the introduction of an auxiliary voltage signal applied to one of the two poles of the quadrupole, two additional pairs of opposing electrodes (209A/209B, 210A/210B) are inserted between the rods of the pre-filter and at least one of the pairs of electrodes (290A/209B) are connected via transformer to the auxiliary RF voltage source 208. The transformer 207 provides a method for infecting a DC offset through a center tap into the auxiliary electrodes. A DC offset can also be provided to auxiliary electrode pair 210A/210B which has not been shown. As with the embodiment of FIG. 22, the auxiliary RF voltage is chosen to remove ions satisfying certain frequencies according to the Mathieu stability parameters. As would be appreciated, while two pairs of auxiliary electrodes have been depicted in the embodiment of FIG. 22, only one pair is necessary for the generation of the auxiliary RF field. Such one pair embodiments are also intended to be included in the within teachings.

Pulsing a frequency, f₀, for a short period of time will result in a spread of frequencies centered upon that frequency. The approximate minimum spread in frequency (Δf_{f}) can be found using the expression

$$Δ {f}_{f} = \frac{{f}_{0}}{N}$$

where N is the number of cycles of f₀ that occur during the excitation period (Arfken, G. Mathematical Methods for Physicists; Academic: New York, 1968; p 530, its contents incorporated by reference). The amplitude of the frequency components in the spread will decrease the further away that component is from the primary frequency f₀ (French, A. P. Waves and Vibrations; W.W. Norton & Company, Inc.: New York, 1971; p 216-223, its contents incorporated by reference). In order to remove different types of ions from the pre-filter, it is necessary to overlap the frequency spreads from different primary frequencies in order to cover a sufficient frequency range with enough amplitude. The ions are removed by driving them to the rods A′ and A″ (using for example the apparatus described in FIG. 22), where the ions are neutralized upon impact with the rod surface.

The duration of the pulse can also be used to calculate the frequency spread of the applied auxiliary pulse. The frequency spread is simply the inverse of the pulse duration, i.e.

$$Δ {f}_{f} = \frac{1}{pulse\_duration}$$

Table 1 shows some examples of Mathieu q values, β values and secular frequency for a few ions when using a drive frequency of 1 MHz. It has been assumed that the ions are trapped at the same V_{rf} level so that their Mathieu q values are inversely proportional. The secular frequencies were calculated using the continued fraction expression for β.

TABLE 1

| | | | Secular Frequency |
|---|---|---|---|
| Mass | Mathieu q | Beta value | (kHz) |
| 250 | 0.88 | 0.8427 | 421.4 |
| 500 | 0.44 | 0.3244 | 162.2 |
| 1000 | 0.22 | 0.1571 | 78.6 |

Table 2 shows frequency spreads calculated for auxiliary RF signals applied for 10 microseconds at the secular frequencies calculated in Table 1. All of the calculated frequency spreads are 100 kHz which corresponds to the calculated spread obtained using either of the definitions for the minimum frequency spread or the spread calculated from pulse duration referred to above.

TABLE 2

| | Applied Frequency | Number of Cycles | Frequency Spread |
|---|---|---|---|
| Mass | (kHz) | (N) | (kHz) |
| 250 | 421.4 | 4.2 | 100 |
| 500 | 162.2 | 1.6 | 100 |
| 1000 | 78.6 | 0.8 | 100 |

In order to cover the range of ions trapped in the pre-filter it would be necessary to excite with several primary frequency components spaced to cover the frequency range from the lowest expected secular frequency (highest mass) to the highest expected secular frequency (lowest mass) that may be trapped in the pre-filter. This is similar to applying a broadband excitation in which the composite waveform is created using a comb of frequencies that are equally spaced. The spacing of the components can be different between each frequency to allow for the fact that the amplitude required to remove trapped ions will be mass dependent with heavier masses requiring greater amplitudes then lighter masses. The frequency spread can be increased by using a shorter pulse duration, but this may require a higher pulse amplitude, if the frequency components associated with each primary frequency become too weak to remove the trapped ions.

It should be understood that the foregoing description of numerous embodiments has been presented for purposes of illustration and description. It is not exhaustive and does not limit the claimed inventions to the precise forms disclosed. Modifications and variations are possible in light of the above description or may be acquired from practicing the invention. The claims and their equivalents define the scope of the invention.

In particular, while embodiments have been described in which the clear out pulse creates a gradient that drives unwanted ions towards one of the rods, it would be appreciated that ions could also be cleared by driving ions away from one of the rods. In this manner, the potential of the clear out pulse applied to one of the rods is such that a gradient is created that moves ions away from the rod with the applied clear out pulse applied and towards the remaining rods. In this embodiment however, a higher pulse amplitude is required to be applied to the one rod in order to impart sufficient kinetic energy to the ions to overcome the pseudo-potential trapping barrier than is necessary than in the embodiment when the ions are attracted to the one rod with the applied pulse.

In addition, while embodiments have been described wherein a tandem mass spectrometer involves the presence of multiple multipole devices, it would be appreciated that the within described teachings can be used in other tandem mass spectrometer configurations such as for example, where the last mass spectrometer is a time-of-flight device.

1. A method of clearing ions from a quadrupole ion transmission device, the quadrupole having a series of four rods arranged circumferentially around and equidistant from a longitudinal axis, each of said rods being connected to a RF generator source and controller so as to generate a quadrupole field for trapping the ions within the quadrupole ion transmission device, the method comprising applying a DC pulse to one, two or three of the rods, the DC pulse being such that the kinetic energy gained by the ions as a result of the DC pulse overcomes the radial trapping force generated by the quadrupole field.

2. The method of claim 1 wherein the amplitude of the DC pulse is increased to provide the kinetic energy.

3. The method of claim 1 wherein the DC pulse is applied to only one of the rods.

4. (canceled)

5. The method of claim 1 wherein the DC pulse is applied to two adjacent rods of the series of rods.

6. The method of claim 4 wherein the DC pulse is applied to two non-adjacent rods of the series of rods.

7. The method of claim 1 wherein the quadrupole operates as a pre-filter and is situated directly upstream of at least one filtering quadrupole.

8. The method of claim 1 wherein the quadrupole is part of a tandem mass spectrometer.

9. The method of claim 1 wherein the DC pulse causes ions to move towards the one, two or three rods with the applied DC pulse.

10-15. (canceled)

16. A quadrupole device for use in transporting ions in a mass spectrometer comprising:
four rods arranged circumferentially around and equidistant from a longitudinal axis;
at least one RF potential supply that is electrically connected to each of the four rods for generating a quadrupole field capable of trapping ions;
at least one DC potential supply that is electrically connected to at least one of the rods;
one or more controllers for controlling the RF and DC potential applied to the four rods;
wherein the one or more controllers is configured to switch between one of two modes, wherein in the first mode, the DC potential on each of the four rods is the same, and in the second mode, the DC potential on one or two of the rods is the same and held at a potential that differs from the DC potential on the remaining rods.

17. The device of claim 16 wherein the mass spectrometer is a tandem mass spectrometer

18. The device of claim 16 wherein the quadrupole device operates as a pre-filter and is situated directly upstream of at least one filtering quadrupole.

19. The device of claim 16 wherein the DC potential is electrically connected to only one of the four rods for the application of a DC pulse.

20. The device of claim 16 wherein in the second mode, the DC potential supplied imparts sufficient kinetic energy to the ions to overcome a trapping field that traps ions that is generated by the quadrupole field.

21. The device of claim 20 wherein the controller is configured such that in the second mode, the DC potential on one of the rods differs from the DC potential on the other three rods and is selected so as to cause ions to move towards the one rod that has the differing DC potential.

22. The device of claim 16 wherein the controller is configured such that in the second mode, the DC potential on two adjacent rods is the same and differs from a DC potential on the other two rods.

23. The device of claim 16 wherein the controller is configured such that in the second mode, the DC potential on two non-adjacent rods is the same and differs from a DC potential on the other two rods.

24. (canceled)

25. A method of clearing ions from a second quadrupole, the second quadrupole being situated in series and upstream from a first quadrupole, said method comprising:
electrically connecting a first pair of rods in the first quadrupole to a first pair of rods in the second quadrupole by way of a capacitor situated therebetween,
electrically connecting a second pair of rods in the first quadrupole to a second pair of rods in the second quadrupole by way of capacitor situated therebetween,
providing RF and DC voltage supplies to the second quadrupole such that the second quadrupole operates as a mass filter,
pulsing the DC voltage on the first and/or second pair of rods in the second quadrupole, wherein the pulsing causes a resolving DC field in the first quadrupole to form.

26. (canceled)
